(19) United States
(12) Patent Application Publication
(10) Pub. No.: US 2008/0272112 A1
(43) Pub. Date: Nov. 6, 2008

(54) Hard-Soldering Method and Device

(75) Inventor: Werner Urech, Kaiserstuhl (CH)

Correspondence Address: MCCORMICK, PAULDING & HUBER LLP, CITY PLACE II, 185 ASYLUM STREET, HARTFORD, CT, 06103, US

(73) Assignee: Soutec Soudronic AG, Neftenbach (CH)

(21) Appl. No.: 11/628,093

(22) PCT Filed: May 20, 2005
(86) PCT No.: PCT/CH05/00287

§ 371 Date: Jan. 29, 2007

(30) Foreign Application Priority Data
Jun. 1, 2004 (CH) 928/04

(51) Int. Cl. B23K 1/002; B23K 1/005; B23K 3/047; B23K 3/06; B23K 31/02; B23K 26/20; B23K 9/00; B23K 5/00; B23K 3/08

(52) U.S. Cl. 219/616; 228/256; 228/102; 219/121.64; 219/121.46; 228/219; 228/33; 228/9; 219/121.63; 219/121.45; 219/137 R; 219/136; 228/18

(57) ABSTRACT

To hard-solder parts to be joined along a common joint, the parts are heated by a heat source e.g. a laser beam (3). Melted solder (7) that is stored in a container (6) is then introduced into the joint. Joints can be filled with solder in this manner at higher speed and the solidified solder surface is practically devoid of pores, thus permitting the priming or painting of said parts without the need for subsequent treatment.

The invention concerns a method for connecting metallic joint parts by hard-soldering, wherein the joint parts are heated by a heat source and the joint between the joint parts are filled with solder. The invention further concerns a device for carrying out the method.

The connection of metallic parts (joint parts) by hard-soldering is known; the same or different metals are connectable in this way (for example, steel/steel or aluminum/steel). In the construction of automobile bodies, for example, side pieces and roof pieces of automobile bodies are connected with one another by soldering, with the solder also filling the joint between the parts and forming an outer surface permitting its priming and painting without further processing, so that no measures for covering the joint need be taken, as is the case for a welded connection of the mentioned parts. Especially in this application, but also in the case of other hard-soldered connections, value is placed on an outer surface of the joint as possible pore free as possible by the filling with solidified solder, and, as well, on a filling height as uniform as possible even in the case of varying joint widths and accordingly with changing amounts solder. WO 02/064300 shows soldering with a burner and with prewarming of the solder wire. In practice it is also known to heat the joint parts to be soldered with a laser and to likewise feed the soldering wire into the laser beam, so that the laser beam melts the solder wire. Especially in the case of zinc coated sheets, whose coating beyond the joint should remain as intact as possible (vaporization temperature of the zinc at 1060° C.), and where the CuSi or copper/zinc solder having a melting point of 980 to 1060° C. is used, a problem free and pore free outer surface of the solidified solder is achieved only at low welding speeds of about 2 to 3 m/min. The solders which can be used, with differing compositions, are known to persons skilled in the art.

The object of the invention is therefore basically to provide an improved hard-soldering method by means of which a good outer surface quality of the solidified solder is obtainable at higher soldering speeds.

This object is solved by the features of claim 1.

Thus, a container with a supply of liquid solder is provided, and the heating of the soldering site and the liquification of the solder are completely separated from one another. The heating of the joint parts can thereby be exactly controlled and especially also the danger of vaporizing the zinc coating by over heating can be avoided, since no energy for the melting of the solder is taken from the energy beam which heats the joint parts. Also the temperature of the solder can in this way be exactly adjusted so that by the method of the invention the soldering can take place at an optimum temperature level, which leads to a good surface quality of the solidified solder. Further, the amount of liquid solder dispensed from the supply can be more simply suited to the changing joint measurement than in the case of the delivery of a rigid solder wire, and the changing amount of the delivered solder also in this case has no influence on the heating of the joint parts.

It is preferred that the liquid solder and the soldering process be applied to the joint parts behind the zone at which the heat source works on the joint parts. This permits an optimal preparation of the solder application zone by the cleaning or the deoxidation effect of the heat source on the joint region. One such effect can be created by the application of a gas or gas mixture with or without the mixing of powdered deoxidation agents with the gas in the heating region. In comparison to this, in accordance with the state of the art and with the use of solidified solder wire, it is in practice usual to introduce or drag the solder wire in advance of the heating region so that the solder melted by the laser beam must flow around the beam or under the beam. Therefore the cleaning or deoxidation effect of the laser beam on the sheet outer surface can not be used to full effect. A delivery of the solder wire from the other side, that is penetratively, precludes the possibility of a locking or hanging up of the solder wire, which would lead to an interruption of the soldering process.

Preferably the controlled placement of the liquid solder from the supply into the joint takes place not only on the basis of fixed control parameters dependent on the forward speed, but additionally on the basis of an inspection of the joint, especially of its measurement in advance of the filling, as for example by optical inspection means. Accordingly, the amount of the applied solder can be adjusted to the changes in the joint size along the joint, so that along the joint seam a uniformly filled joint without a visible variation in the shape of the seam outer surface along the joint is continuously maintained. Also an inspection of the already filled joint, for example likewise by optical inspection, can be used to derive a control value. In a similar way a temperature measurement of the heated joint parts before and/or after the solder placement can be used.

The discharge of the solder from the container can in the case of a closed container be precisely controlled by a high or low pressure in the container. In connection with this, a controllable element, for example a plunger, can be provided which by way of a drive means can be more or less insertable into or withdrawable from the container. This element can preferably be formed by the solder wire which is driven into the container for melting. However, the controllable element can, for example, be a flexible container wall or a part thereof onto which a force is exerted in order to cause or stop the discharge of the liquid solder. In the case of an open container the container can be more or less tipped and moved rearwardly to control the amount of the discharge and its starting and stopping.

In the following further developments and advantages of the invention are explained in more detail with the help of the drawings illustrating exemplary embodiments of the invention. In the drawings:

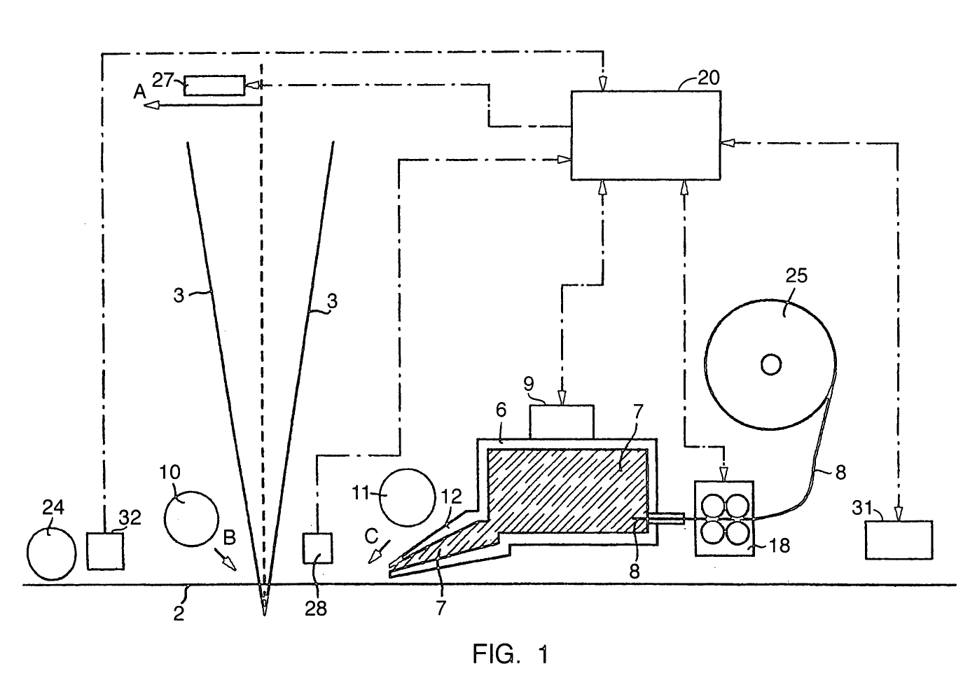

FIG. 1 is a schematic view of a first device for carrying out the method;

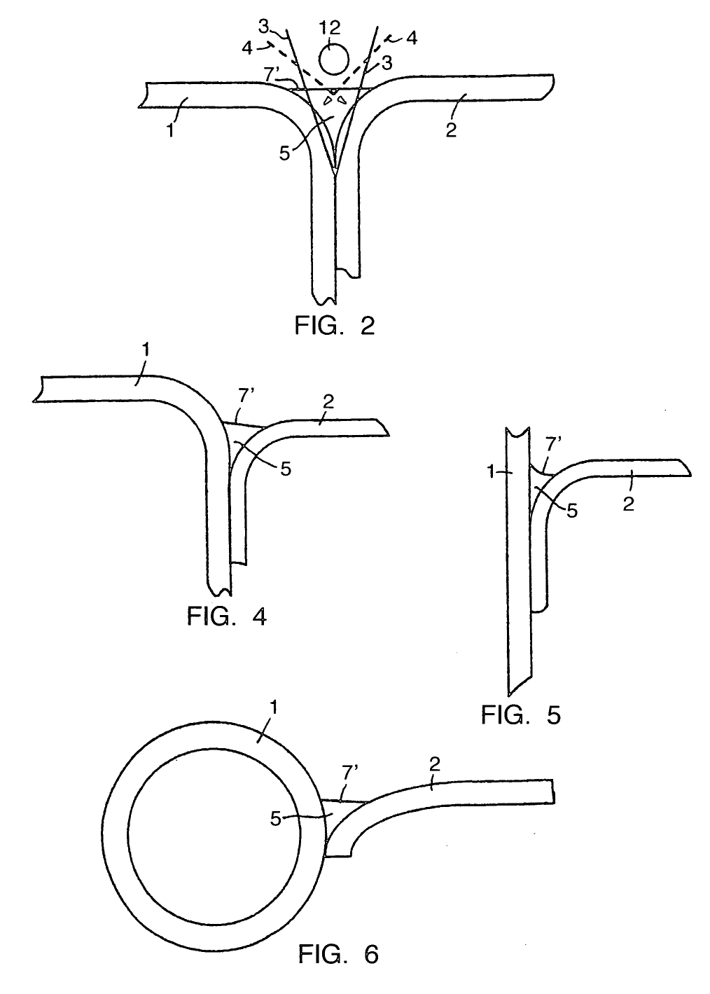

FIG. 2 is a view onto the joint parts taken in the longitudinal direction of the joint;

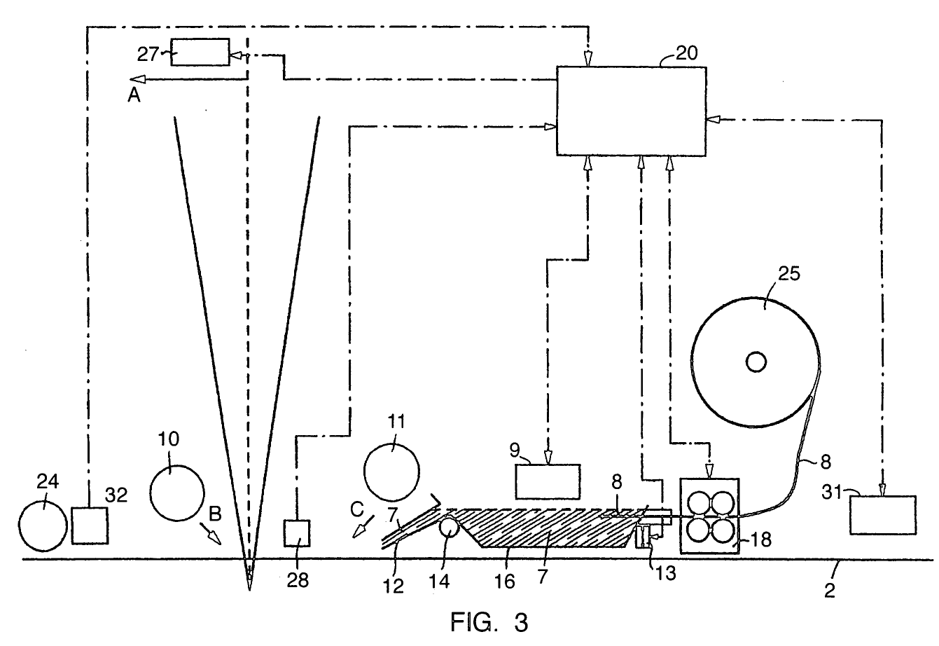

FIG. 3 is a schematic view of a further device for carrying out the method; and

FIGS. 4 to 6 are several types of joint parts for which the invention is advantageously usable.

FIG. 1 shows a first embodiment of a device by means of which the method of the invention may be carried out. The figure is a largely schematic view of the device. By means of the device, joint parts 1, 2, as for example illustrated in FIG. 2, are connected with one another by hard soldering whereby the solder more or less fills up the joint 5 existing between the joint parts 1, 2; and after the hardening, the solder forms a mostly pore free outer surface which without or with only a small amount of subsequent processing can be primed and painted. The joint 5 should be uniformly filled as much as possible so that the solder forms a uniform visible joint filling, for example in the case of vehicle body parts, between a first joint part 1 forming a roof part and a second joint part 2 forming a side part of an automobile body. This naturally is to be taken only as an example, as optionally other metallic joint parts (as previously mentioned possibly consisting of different metals) can be connected according to the invention. The joint pieces can additionally be joined by further connecting means, for example by a stitching of spot welds below the joint 5. In the schematic side view of FIG. 1, the joint part 2 is there schematically illustrated by the horizontal line, and the further joint part 1 (FIG. 2) which forms the joint to be filled is not visible in FIG. 1. The joint parts 1, 2 are so heated by means of a first heat source in the region of the joint that they become prepared for the soldering. The degree of heating can begin basically at the lower boundary of the hard soldering range of about 450° C. and can be as much as the necessary soldering temperature, which naturally is dependent on the solder used, and which for example in the case of the hard solder used in the automobile industry can be about 950° C. to about 1030° C. or 1060° C. By means of the heat source 3, as much as possible, only the soldering region is brought to this temperature in order to avoid a negative heat influence on the neighboring regions of the joint parts 1, 2, since the soldering of coated sheets can be involved, preferably zinc coated sheets, which sheets should not be subjected to any high temperatures. The heat source 3 can, for example, be a laser beam, which in the drawing is indicated only by the peripheral rays 3. The focus of the laser beam 3 lies in general below the joint 5 in order to achieve an as much as possible good and uniform heating of the joint parts 1, 2 in the joint region and in the region of emplaced solder. Instead of one laser beam 3 several beams can be used, for example as indicated by the beam paths 4 of FIG. 2. Naturally, in place of the single laser beam 3 optionally other heat sources can be used which heat the joint pieces 1, 2 in the joint area to the needed soldering temperature. Such sources can, for example, be plasma ray sources, electric arc sources, flame sources or inductive heating means.

The heat source, for example the laser beam 3, is moved along the joint 5 so that the region of the joint is progressively heated and then filled with solder. A movement of the heat source and the other parts of the heating device which are movable relative to the joint can accordingly be accomplished such that the device is moved over the stationary standing joint parts 1, 2, or the joint parts 1,2 are moved past the stationary standing device. In FIG. 1 this is illustrated by an arrow A the laser beam, which arrow represents the movement direction, and a box 27 which symbolically represents all of the needed driving means needed to achieve the movement of the device and joint parts 1, 2 relative to one another. The make up of such driving means is known to persons skilled in the art and need not be explained in more detail here. All known types of driving means are possible. These driving means can be controlled by the control arrangement 20 of the device, which control is indicated by an associated dash-dot control line to the box 27. The control arrangement 20 however can also communicate with a separate control device for the driving means to obtain information about the movement and in turn provide information about the soldering to the driving means.

According to the invention, therefore, a supply of liquid solder 7 is supplied in a container 6, which heats the solder to fluid condition for filling the joint between the joint parts 1, 2. In FIG. 1 this is indicated by the container 6 in which the liquid solder 7 is shown by cross-hatching. The liquid solder 7 is then placed into the joint from the container and as directly as possible to the region of the joint parts 1, 2 heated by the heat source, with the liquid solder being poured into or injected into the joint. A shown in FIG. 1, the spacing between the laser beam 3 and the container 6 and the outlet 12 for the liquid solder is to be taken as only a schematic representation and does not show exactly the real spacing between the region of the joint parts 1, 2 affected by the laser beam 3 and the outlet opening or spout 12 of the container 6. The filling of solder into the joint occurs thusly where the joint parts have the temperature necessary for the soldering. In regard to this a temperature measuring means 28 can be provided, which at least provides to the control arrangement 20 of the device a measured value of the temperature of the heated joint parts. It can also be that the spacing of the container 6 and its discharge end from the laser beam 3 is adjustable and that such spacing especially is variable by the control arrangement 20 during the operation of the device.

The solder is held in liquid condition in the container 6. The container 6 may have a heating means, which in the Figure is schematically illustrated at 9 and which likewise is controlled by the control arrangement 20. The heating means can be so implemented that it maintains in a fluid condition the solder which is delivered to the container 6 in an already fluid condition, or it can be so constructed that solder delivered to the container 6 in solid form is melted in the container and is then held in fluid condition in the container. This latter implementation is illustrated in the Figure in which a solid soldering wire 8 is drawn from a supply 25 by a soldering wire delivery device 18 and inserted into the container 6, where the soldering wire 8 melts and in molten condition forms the liquid solder supply 7.

From the supply of liquid solder 7 the liquid solder is placed into the joint 5 and forms there a solder filling, the upper surface of which in FIG. 2 is indicated by the line 7′. In FIG. 2 the outlet of the container 6 is further indicated at 12. (Also several outlets 12 can be provided, in each case according to the arrangement of joint 5 so that liquid solder can be placed into the joint in an optimal way). The heating means 9 for the container can be of any optional design by means which the solder can be melted and held in a liquid condition, for example, by resistance heating means or inductive heating means. It is also possible to conduct the heating energy from the heat source, so that the heating means 9 is formed from the same heat source as used for the heating of the joint parts. Container 6 can be insulated and consists of a material which is not attacked by the liquid solder and which does not adhere itself to the liquid solder so that a discharge of the solder is not possible. The container can for example be made of a high temperature resisting metal or of a ceramic material.

In FIG. 1 a closed container is illustrated from which the discharge of solder can be so achieved in that to start the discharge of solder through the outlet 12 of the container a high pressure is created and to stop the discharge of the solder a reduced pressure, for example a low pressure, is created. This can result by way of a force effect on the container whereby the container or wall portions of the container are more or less compressed. After the start of the flow, the solder can flow with constant amount (specifically through the outlet) and the filling of the joint is controlled by the relative speed between the joint and the outlet. The discharge of solder can also be varied in its amount by the high or low pressure, which is preferred in comparison to an operation with only starting and stopping of the solder discharge. In the shown example the control, or the high and low pressure creation in the closed container, takes place in that a solid solder wire 8 is driven into the container by the delivery means 18 under the control of the control apparatus 20 at a predetermined speed, is stopped, or is partially withdrawn at a predetermined speed. In this manner, by way of the additionally inserted, or as the case may be withdrawn, solder volume in the container the resulting pressure change, for example as a high or low pressure, can be adjusted. The adjustment leads to a corresponding solder discharge through the single opening of the container, which is formed at the end of the spout 12. However, other means not formed by the soldering wire 8 can be provided. For example, a plunger insertable into or withdrawable from the container can be used for the control of the high or low pressure.

Accordingly, the liquid solder flows into the joint and fills it, for example on the basis of control parameters from the control arrangement 20 which are dependent on the forward speed so that the more solder is delivered, the higher the forward speed of the heating source 3 and the container 6 relative to the joint parts 1, 2.

Preferably an inspection means 32 is provided which, for example, at each spot on the length of the joint, determines the size of the joint corresponding to the manufacturing and bending tolerances of the joint parts 1, 2, and provides corresponding control values to the control arrangement 20. The placement of the solder can therefore be so controlled that in the regions of small joint volumes lesser amounts of solder, and in the regions of greater joint volumes greater amounts of solder, are introduced, so that a solder outer surface 7′ as uniform as possible is created along the joint. The inspection means 32 can thereby inspect the joint in optionally known ways, for example by optical means. An inspection device 31 can also be provided which inspects the outer surface of the hardened solder and supplies corresponding signals, for example, about the abundance of pores, to the control means 20. The control means can then have a corresponding effect on the heat source 38, which in the Figure is indicated solely by a control conductor from the control arrangement 20 to the laser beam 3 and can have an influence on the temperature of the liquid solder by way of the heating means 9.

In front of the effective zone of the heat source, or in front of the laser beam 3, a mechanical cleaning of the joint by a cleaning means 24 can be provided. In the heat application zone itself there results a cleaning and a deoxidation by way of the heat of the heat source or laser beam 3. The deoxidation can be increased by the application of a gas or gas mixture with or without the addition of powdered deoxidation materials, with the gas source and a source for the addition of deoxidation material being indicated in the Figure at 10, and the gaseous stream and the stream of deoxidation material being indicated solely by the arrow B. For the placement of the solder a protective gas can be provided, which in the Figure is likewise only indicated by the gas source 11 and the arrow C. The functions of a cleaning supporting gas and of a protective gas can also be filled by a single gas source which is used in place of the two indicated gas sources 10 and 11.

FIG. 3 shows a further exemplary embodiment of the device wherein the same reference numbers and letters indicate essentially the same elements, and all variations explained for the previous exemplary embodiment also apply for the exemplary embodiment of FIG. 3 insofar as they are meaningfully useful therein. Instead of a closed container, in FIG. 3 an open container 16 is illustrated which again has a discharge spout 12. The solder 7 is located in the container in a fluid state and is maintained in the fluid state by the heating means 9. Here the discharge now takes place in that the container is pivoted about a pivot axis 14 and in that by means of a lifting and lowering means 13 at its end opposite to the pivot axis 14, the container at that end is liftable and lowerable. Accordingly, there results a discharge of liquid solder from the container or no discharge depending on whether the fill level of the liquid solder reaches to the spout 12 of the container or does not reach to the spout 12. The lifting and lowering means 13 are again controlled by the control arrangement 20 in order to place the solder in the joint 7 with the best possible dosing.

FIGS. 4, 5 and 6 show different variations of joint parts 1, 2 which between themselves form a joint. Also indicated in each figure is the outer surface 7′ of the solder which fills the joint. Instead of the illustrated flanged joint parts, for example, joint parts which border one another in a flush fashion can correspondingly be soldered in accordance with the invention, as well as, for example, joint parts with inclined forward faces for defining the joint.

The method according to the invention and the device according to the invention permit, because of the joint quality achievable by the invention, the increased use of silver free solder without the quality of the solder seam being relevantly influenced in comparison to that of solder seams previously obtained with the use of silver containing solder.

Further, the method of the invention and the device of the invention are also useable if the outer surface of the metal parts to be joined have begun to melt.

1. A method for the connection of metallic joint parts (1,2) by hard solder, wherein the joint parts (1,2) are heated by at least one heat source (3;4) and the joint (5) between the joint parts (1,2) is filled with solder, characterized in that the solder is placed into the joint (5) from a container (6;16) containing a supply of liquid solder (7) with the placing of the solder being controlled, especially dosed, by a control arrangement (20).

2. A method according to claim 1 further characterized in that the at least one heat source (3;4) and the container (6) are controllably moved relative to the joint, especially the same being controllably moved by the control arrangement (20), with the container (6;16) especially following behind the heat source in the movement direction.

3. A method according to claim 1 further characterized in that the solder delivered from the container into the joint is controlled in dependence on an inspection of the joint and/or a temperature measurement in advance of the solder placement and/or an inspection of solder filled joint 5.

4. A method according to claim 3 further characterized in that the inspection is accomplished by way of optical and/or acoustic an/or magnetic and/or mechanical inspection means.

5. A method according to claim 1, further characterized in that the placement of the solder into the joint is influenced by the control arrangement in that in a dosed container (6) a pressure change, especially a high pressure or a low pressure with respect to atmospheric pressure, is created, or in that in the case of an open container (16), the container is more or less pivoted with respect to a discharge position.

6. A method according to claim 5, further characterized in that the high pressure or the low pressure in the container is achieved by the delivery to the container of meltable solid solder (8), especially in the form of a solder wire 8.

7. A method according to claim 1 further characterized in that the container has at least one discharge opening (12).

8. A method according to claim 1 further characterized in that the at least one heat source (3;4) is a laser beam source and/or a plasma beam source and/or an electric arc source and/or a flame source and/or an inductive heating means.

9. A method according to claim 1 further characterized in that the solder in the container is maintained in a liquid condition by a heat source (9) independent of the at least one heat source or by the at least one heat source, and in that the solder is a solder meltable in the region of from 450° C. to 1060° C., especially in the region of 950° C. to 1030° C., the solder especially being a silver free solder.

10. A method according to claim 1 further characterized in that a deoxidation of the joint parts by the heat source takes place, especially with the delivery of a gas or a gas mixture and/or with the addition of a powdered deoxidizing material (10).

11. A method according to claim 1 further characterized in that the liquid solder is placed into the joint under a protective gas (11).

12. A method according to claim 1 further characterized in that the joint parts (1,2) are parts of an automobile body construction, especially coated construction parts and more especially zinc coated construction parts.

13. A method according to claim 1 further characterized in that the joint parts are directly overlapped or by means of one sided or double sided flanges (21,22) are joined to one another.

14. A device for the connection of joint parts (1,2) by means of hard-soldering, including at least one heat source (3;4), a solder delivery arrangement as well as means (27) for the relative movement of the joint parts (1,2) on one hand and heat source and the solder delivery arrangement on the other hand, characterized in that the solder delivery arrangement has a heatable container (6;16) for receiving a supply of liquid solder (7), and placement means (12;13,14;18) through which the liquid solder (7) is placeable into the joint (5) between the joint parts heated by the heat source.

15. The arrangement according to claim 14, further characterized in that a control arrangement (20) is provided which controls the speed of movement of the heat source and the container relative to the joint parts and/or the amount of the solder (7) placed into the joint from the container (6;16).

16. A device according to claim 15, further characterized in that the control arrangement is constructed so as to be dependent on a joint inspection device (32) and/or on a temperature measuring device (28) and/or on a solder seam inspection device (31), which inspection device especially includes optical recognition means.

17. A device according to claim 14 further characterized in that the container is a closed container (6) the discharge of solder from which is controllable by means (8,18,20) for creating a high pressure or an low pressure.

18. A device according to claim 17, further characterized in that the means for creating the high pressure or the low pressure includes an element insertable to a greater or lesser degree into the container, with that element especially being formed by a solder wire (8) insertable into the container by a controllable wire delivery means (18).

19. A device according to claim 16, further characterized in that the container is an open container (16) the solder discharge of which is controllable by pivoting means (13,14) for the container.

20. A device according to claim 14 further characterized in that the container has at least one discharge opening (12).

21. A device according to claim 14 further characterized in that the at least one heat source is a laser beam source and/or a plasma beam source and/or an electric arc source and/or a flame source and/or an inductive heating means.

22. A device according to claim 14 further characterized in that the solder in the container is liquefiable by a heat source (9) independent of the at least one heat source.

23. A device according to claim 14 further characterized by a mechanical cleaning means (24) for the joint.

24. A device according to claim 14 further characterized by a gas delivery means (10) by means of which a gas is deliverable to the effective region of the heat source.

25. A device according to claim 14, further characterized by a protective gas delivery means (11) by means of which gas is deliverable to the emplacement region of the solder.
